(19) United States
(12) Patent Application Publication
(10) Pub. No.: US 2021/0126986 A1
(43) Pub. Date: Apr. 29, 2021

(54) DISTRIBUTED PROCESSING SYSTEM AND METHOD FOR THE PROVISION OF LOCATION BASED SERVICES

(71) Applicant: HERE Global B.V., Eindhoven (NL)

(72) Inventors: Daniel ROLF, Berlin (DE); Raul CAJIAS, Berlin (DE); Alexander GONOPOLSKIY, Berlin (DE)

(73) Assignee: HERE Global B.V., Eindhoven (NL)

(21) Appl. No.: 16/960,126

(22) PCT Filed: Jan. 8, 2019
(86) PCT No.: PCT/IB2019/050133

§ 371 Date: Jul. 6, 2020

Related U.S. Application Data
(60) Provisional application No. 62/614,784, filed on Jan. 8, 2018.

(51) Int. Cl. H04L 29/08; H04W 4/029; H04L 12/24

(52) U.S. Cl. CPC H04L 67/327; H04L 67/18; H04L 67/1095; H04L 41/5096; H04L 67/2842; H04W 4/029

(57) ABSTRACT

A distributed processing system for providing location based services is provided along with a system, method and computer program product for customizing services, such as location based services to be provided onboard a vehicle. The distributed processing system includes a plurality of computing devices including at least one edge device and at least one cloud computing device. Each computing device includes a core component and one or more services. The services may be configured as a pipeline or as microservices. The core component of each computing device is configured to communicate with the one or more services of the respective computing device as well as with the core component of at least one of the other computing devices in order to share data, such as data having a conflict-free replicated data type, and synchronize the core components.

### CROSS-REFERENCE TO RELATED APPLICATION

The present application claims priority to U.S. Provisional Patent Application No. 62/614,784, filed Jan. 8, 2018, the contents of which is incorporated herein by reference in its entirety.

### TECHNOLOGICAL FIELD

An example embodiment is directed to a distributed processing system, method and computer program product for providing location based services and, more particularly, to a distributed processing system, method and computer program product for providing location based services with one or more distributed services configured, for example, as a pipeline or as microservices that communicate and remain synchronized via respective core components.

### BACKGROUND

Location based services are widely utilized. Common examples of location based services include the display of a map, map matching in which the location of a user is identified upon a map, location search functions, routing, guidance and the provision of traffic-related information. Location based services are available via a wide variety of different platforms including navigation systems, smart phones and other types of mobile terminals and the like. Vehicles are increasingly being designed to provide location based services and drivers are passengers are becoming increasingly dependent upon the location based services provided by their vehicles in order to, for example, identify the shortest route to a destination, identify the time at which the vehicle is expected to arrive at the destination, provide advance notice of unusual traffic conditions or congestion, locate a desired destination or a point of interest, or the like.

Some customization of the location based services onboard a vehicle may be provided, such as at the time that a vehicle is purchased or leased or thereafter in conjunction with obtaining updates of map data from a vendor of location based services. However, the customization of the location based services that is available to users in conjunction with their respective vehicles is somewhat limited, thereby correspondingly limiting the utilization and enjoyment of location based services by drivers and their passengers.

### BRIEF SUMMARY

A distributed processing system for providing location based services is provided along with a system, method and computer program product for customizing location based services to be provided onboard a vehicle. As such, the location based services may be customized, both in terms of the type of location based services as well as the subsequent execution of the location based services. A user of the vehicle may thereafter utilize the location based services in a manner that is more consistent with the desires of the user, thereby providing an enhanced user experience.

In an example embodiment, a distributed processing system is disclosed for providing location based services. The distributed processing system comprises a plurality of computing devices including at least one edge device and at least one cloud computing device. Each computing device comprises a core component and one or more services. Instances of the one or more services of one computing device are different than instances of the one or more services of a different computing device. One or more of the services are configured to provide location based services. The core component of each computing device is configured to communicate with the one or more services of the respective computing device as well as with the core component of at least one of the other computing devices in order to share data and synchronize the core components.

The one or services may be selected from a group consisting of a stateful pipeline and a stateless microservice. In this regard, the pipeline comprises a plurality of computations configured to be performed in a sequential manner to generate a value maintained as a state of the pipeline. The core component of a respective computing device that includes the pipeline may be configured to maintain the state of the pipeline. The core component of a respective computing device may be configured to communicate with the core component of another computing device in order to share data and coordinate execution of the pipeline. In an example embodiment, the one or more services comprise a routing microservice and a guidance microservice arranged as an application. In this example embodiment, the core component of a respective computing device is configured to provide an output of the routing microservice to the guidance microservice.

The core component of each computing device may be configured to provide cache management of data for the one or more services. The core component of each computing device may be configured to synchronize data between a plurality of instances of a service. In an example embodiment, the core component of a respective computing device is configured to be responsive to one or more function calls from another core component. The function call received by the core component of the respective computing device of this example embodiment is associated with a user token, and the core component of the respective computing device is further configured to perform one or more operations on data in response to the function call within a secure area assigned exclusively to a user associated with the user token. In an example embodiment, the core components of the plurality of computing devices are configured to share data having a conflict-free replicated data type (CRDT).

In another example embodiment, an apparatus is disclosed for providing location based services. The apparatus includes means for receiving user selection of one or more services. At least one service is associated with a core component and is configured to provide location based services. The apparatus also includes means for communicating with the one or more services as well as with a core component of another computing devices in order to share data and synchronize the core components. The apparatus is caused to communicate in order to obtain the data upon which the location based services are based. The apparatus further includes means for storing a state of the at least one service that was selected in the core component associated with the service that was selected following execution of the at least one service that was selected.

The one or services are selected in accordance with an example embodiment from a group consisting of a stateful pipeline and a stateless microservice. In this regard, the pipeline may comprise a plurality of computations configured to be performed in a sequential manner to generate a value maintained as a state of the pipeline. The core component that is associated with the pipeline may be configured to maintain the state of the pipeline. In an example embodiment, the one or more services comprise a routing microservice and a guidance microservice arranged as an application. The core component associated with the one or more services of this example embodiment is configured to provide an output of the routing microservice to the guidance microservice.

The means for storing the state of at least one service may provide cache management of the data for the one or more services. The apparatus of an example embodiment further includes means for synchronizing data between a plurality of instances of a service. In an example embodiment, the apparatus further includes means for receiving one or more function calls from another core component. The function call that is received is associated with a user token. The apparatus of this example embodiment also includes means for performing one or more operations on data in response to the function call within a secure area assigned exclusively to a user associated with the user token. The apparatus of an example embodiment further includes means for receiving, for at least some of the one or more services, user selection as to whether a respective service will be executed by an edge device or in a cloud and means for providing feedback based on whether the respective service will be executed by the edge device or in the cloud. The feedback includes one or more parameters relating to processor usage, memory usage, mobile data consumption, number of processes or number of threads. In an example embodiment, the apparatus further includes means, following execution of one or more services, for providing additional feedback relating to processor usage, memory usage, mobile data consumption, number of processes or number of threads.

In a further example embodiment, an apparatus is disclosed for providing location based services. The apparatus includes at least one processor and at least one memory including computer program code. The at least one memory and the computer program code are configured to, with the processor, cause the apparatus to receive user selection of one or more services. At least one service is associated with a core component and is configured to provide location based services. The at least one memory and the computer program code are also configured to, with the processor, cause the apparatus to communicate with the one or more services as well as with a core component of another computing devices in order to share data and synchronize the core components. The at least one memory and the computer program code are configured to, with the processor, cause the apparatus to communicate in order to obtain the data upon which the location based services are based. The at least one memory and the computer program code are further configured to, with the processor, cause the apparatus to store a state of the at least one service that was selected in the core component associated with the service that was selected following execution of the at least one service that was selected.

The one or services are selected in accordance with an example embodiment from a group consisting of a stateful pipeline and a stateless microservice. In this regard, the pipeline may comprise a plurality of computations configured to be performed in a sequential manner to generate a value maintained as a state of the pipeline. The core component that is associated with the pipeline may be configured to maintain the state of the pipeline. In an example embodiment, the one or more services comprise a routing microservice and a guidance microservice arranged as an application. The core component associated with the one or more services of this example embodiment is configured to provide an output of the routing microservice to the guidance microservice.

The at least one memory and the computer program code are configured to, with the processor, cause the apparatus of an example embodiment to store the state of at least one service in order to provide cache management of the data for the one or more services. The at least one memory and the computer program code are configured to, with the processor, cause the apparatus of an example embodiment to synchronize data between a plurality of instances of a service. In an example embodiment, the at least one memory and the computer program code are further configured to, with the processor, cause the apparatus of an example embodiment to receive one or more function calls from another core component. The function call that is received is associated with a user token. The at least one memory and the computer program code are configured to, with the processor, cause the apparatus of this example embodiment to perform one or more operations on data in response to the function call within a secure area assigned exclusively to a user associated with the user token. The at least one memory and the computer program code are configured to, with the processor, cause the apparatus of an example embodiment to receive, for at least some of the one or more services, user selection as to whether a respective service will be executed by an edge device or in a cloud and to provide feedback based on whether the respective service will be executed by the edge device or in the cloud. The feedback includes one or more parameters relating to processor usage, memory usage, mobile data consumption, number of processes or number of threads. In an example embodiment, the at least one memory and the computer program code are further configured to, with the processor, cause the apparatus of an example embodiment to, following execution of one or more services, for providing additional feedback relating to processor usage, memory usage, mobile data consumption, number of processes or number of threads.

In another example embodiment, a method is disclosed for providing location based services. The method comprises receiving user selection of one or more services. At least one service is associated with a core component and is configured to provide location based services. The method further comprises communicating with the one or more services as well as with a core component of another computing devices in order to share data and synchronize the core components. In this regard, the method communicates in order to obtain the data upon which the location based services are based. The method also includes storing a state of the at least one service that was selected in the core component associated with the service that was selected following execution of the at least one service that was selected.

The one or services may be selected from a group consisting of a stateful pipeline and a stateless microservice. In this regard, the pipeline may comprise a plurality of computations configured to be performed in a sequential manner to generate a value maintained as a state of the pipeline. The core component that is associated with the pipeline may be configured to maintain the state of the pipeline. In an example embodiment, the one or more services comprise a routing microservice and a guidance microservice arranged as an application. The core component of this example embodiment that is associated with the one or more services is configured to provide an output of the routing microservice to the guidance microservice. In an example embodiment, storing the state of the at least one service comprises providing cache management of the data for the one or more services. The method of an example embodiment further comprises synchronizing data between a plurality of instances of a service.

The method of an example embodiment further comprises performing one or more operations on data in response to a function call from another core component. The function call that is received is associated with a user token. The one or more operations that are performed within a secure area assigned exclusively to a user associated with the user token. In an example embodiment, the method further comprises receiving, for at least some of the one or more services, user selection as to whether a respective service will be executed by an edge device or in a cloud and providing feedback based on whether the respective service will be executed by the edge device or in the cloud. The feedback comprises one or more parameters relating to processor usage, memory usage, mobile data consumption, number of processes or number of threads. The method of an example embodiment further comprises providing, following execution of one or more services, additional feedback relating to processor usage, memory usage, mobile data consumption, number of processes or number of threads.

In a further example embodiment, a computer program product is disclosed that is configured to provide location based services. The computer program product comprises at least one non-transitory computer-readable storage medium having computer-executable program code instructions stored therein. The program code instructions are configured, upon execution to receive user selection of one or more services. At least one service is associated with a core component and is configured to provide location based services. The program code instructions are also configured to cause communication with the one or more services as well as with a core component of another computing devices in order to share data and synchronize the core components. In this regard, the program code instructions are configured to cause communication in order to obtain the data upon which the location based services are based. The program code instructions are further configured to cause a state of the at least one service that was selected to be stored in the core component associated with the service that was selected following execution of the at least one service that was selected.

The one or services may be selected from a group consisting of a stateful pipeline and a stateless microservice. In this regard, the pipeline may comprise a plurality of computations configured to be performed in a sequential manner to generate a value maintained as a state of the pipeline. The core component that is associated with the pipeline may be configured to maintain the state of the pipeline. In an example embodiment, the one or more services comprise a routing microservice and a guidance microservice arranged as an application. The core component of this example embodiment is associated with the one or more services is configured to provide an output of the routing microservice to the guidance microservice.

In an example embodiment, the program code instructions configured to cause the state of the at least one service to be stored comprise program code instructions configured to provide cache management of the data for the one or more services. The program code instructions of an example embodiment are further configured to synchronize data between a plurality of instances of a service. In an example embodiment, the program code instructions are further configured to perform one or more operations on data in response to a function call from another core component. The function call that is received is associated with a user token. The one or more operations are performed within a secure area assigned exclusively to a user associated with the user token.

In an example embodiment, a distributed processing system is disclosed for providing location based services. The distributed processing system includes a plurality of computing devices including at least one edge device and at least one cloud computing device. Each computing device includes a core component and one or more microservices configured to perform different respective services. The one or more microservices of one computing device are different than the one or more microservices of a different computing device. One or more of the microservices are configured to provide location based services. The core component of each computing device is configured to communicate with the one or more microservices of the respective computing device as well as with the core component of at least one of the other computing devices in order to share data and coordinate execution of the plurality of microservices. The core components of the plurality of computing devices share data having a conflict-free replicated data type (CRDT), thereby providing mathematical certainty to the resolution of any conflicts in the data in order to achieve consistency.

The edge device of one embodiment is onboard a vehicle, such as the navigation system of the vehicle. In an example embodiment, the core component of each computing device is configured to provide cache management of data for the one or more microservices of the respective computing device. The core component of an example embodiment is configured to be responsive to one or more function calls from the core component of another computing device. In this example embodiment, a function call received by the core component is associated with the user token. As such, the core component of this example embodiment is further configured to perform one or more operations on data in response to the function call within a secure area assigned exclusively to a user associated with the user token.

In another example embodiment, a system is provided for customizing location based services to be provided onboard a vehicle. The system includes at least one processor and at least one memory including computer program code. The at least one memory and the computer program code are configured to, with the processor, cause the system to at least receive user selection of one or more microservices with which to configure the vehicle. At least one microservice is configured to provide location based services. For at least some of the one or more microservices, the system is caused to receive user selection as to whether a respective microservice will be executed by an edge device or by a cloud computing device. The system is also caused to provide feedback based on whether the respective microservice will be executed by the edge device or by the cloud computing device. The feedback includes one or more parameters relating to processor usage, memory usage, network bandwidth consumption, mobile data consumption, number of remote procedure calls, a number of processes or a number of threads.

Following the execution of one or more microservices, the system of an example embodiment is also caused to provide additional feedback relating to processor usage, memory usage, network bandwidth consumption, mobile data consumption, number of remote procedure calls, number of processes or number of threads. Following establishment of a route for the vehicle, the system of an example embodiment is caused to provide a code or a link associated with the route to permit another device to access and reconfigure the route based upon the code or the link. Following initial configuration of the vehicle, the system of an example embodiment is caused to receive user selection of one or more additional microservices with which to further configure the vehicle. In this example embodiment, the one or more additional microservices are provided by a microservices marketplace.

A method is also provided for customizing location based services to be provided onboard a vehicle. The method includes receiving user selection of one or more microservices with which to configure the vehicle. At least one microservice is configured to provide location based services. For at least some of the one or more microservices, the method receives user selection as to whether a respective microservice will be executed by an edge device or by a cloud computing device. The method also provides feedback based on whether the respective microservice will be executed by the edge device or by the cloud computing device. The feedback includes one or more parameters relating to processor usage, memory usage, network bandwidth consumption, mobile data consumption, number of remote procedure calls, a number of processes or a number of threads.

A computer program product is also provided for customizing location based services to be provided onboard a vehicle. The computer program product includes at least one non-transitory computer-readable storage medium having computer-executable program code portions stored therein with the computer-executable program code portions comprising program code instructions configured to receive user selection of one or more microservices with which to configure the vehicle. At least one microservice is configured to provide location based services. For at least some of the one or more microservices, the computer-executable program code portions also include program code instructions configured to receive user selection as to whether a respective microservice will be executed by an edge device or by a cloud computing device. The computer-executable program code portions further include program code instructions configured to provide feedback based on whether the respective microservice will be executed by the edge device or by the cloud computing device. The feedback includes one or more parameters relating to processor usage, memory usage, network bandwidth consumption, mobile data consumption, number of remote procedure calls, a number of processes or a number of threads.

An apparatus is also provided for customizing location based services to be provided onboard a vehicle. The apparatus includes means for receiving user selection of one or more microservices with which to configure the vehicle. At least one microservice is configured to provide location based services. For at least some of the one or more microservices, the apparatus also includes means for receiving user selection as to whether a respective microservice will be executed by an edge device or by a cloud computing device. The apparatus further includes means for providing feedback based on whether the respective microservice will be executed by the edge device or by the cloud computing device. The feedback includes one or more parameters relating to processor usage, memory usage, network bandwidth consumption, mobile data consumption, number of remote procedure calls, a number of processes or a number of threads.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram illustrating a distributed processing system for providing location based services in accordance with an example embodiment of the present disclosure;

FIG. 2 is a block diagram of a computing device of the distributed processing system that may be specifically configured in accordance with an example embodiment of the present disclosure;

FIG. 3 is a block diagram illustrating a distributed processing system for providing location based services in accordance with a more detailed example embodiment of the present disclosure;

FIG. 4 is a block diagram of an edge device having a data store microservice in accordance with an example embodiment of the present disclosure;

FIG. 5 is a block diagram of an edge device having an advanced rendering platform microservice in accordance with an example embodiment of the present disclosure;

FIG. 6 is a block diagram of a human machine interface controller in accordance with an example embodiment of the present disclosure;

FIG. 7 is another representation of a distributed processing system in accordance with an example embodiment of the present disclosure;

FIG. 8 is a flow chart illustrating operations performed, such as by the computing device of FIG. 2, in accordance with an example embodiment of the present disclosure; and

FIG. 9 is a perspective view of a portion of a system with which a user may interact in order to customize location based services to be provided onboard a vehicle in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A distributed processing system is disclosed for providing location based services. The distributed processing system may provide a wide variety of location based services including, but not limited to, the display of a map, map matching in which the location of a user is identified upon a map, location search functions, routing, guidance and the provision of traffic-related information. The distributed processing system may provide the location based services in various environments including onboard a vehicle, such as location based services provided by or in conjunction with a navigation system onboard a vehicle.

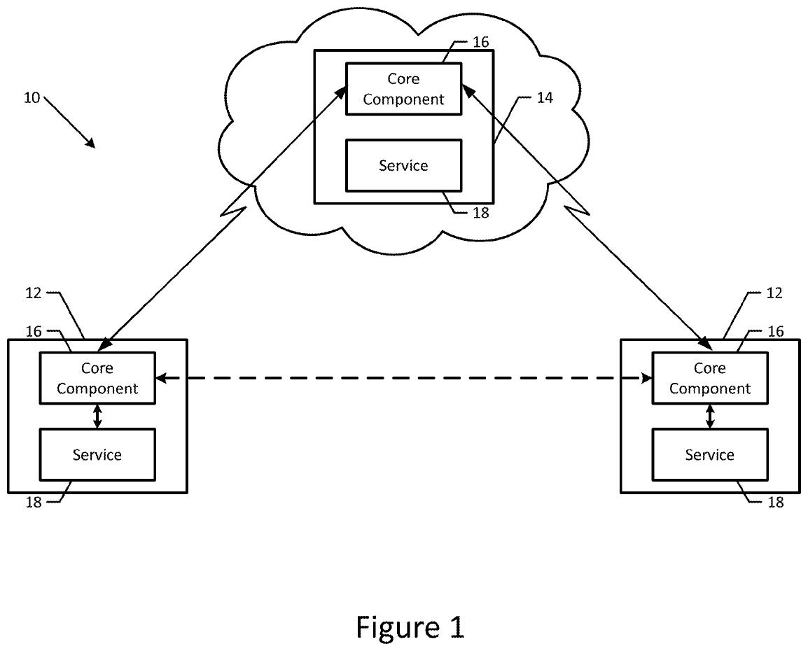

As shown in FIG. 1, a distributed processing system 10 for providing location based services is depicted. As shown, the distributed processing system includes a plurality of computing devices that operate collaboratively in order to provide the location based services. The plurality of computing devices include one or more edge devices 12, that is, remote or non-central devices at the edge of a network that perform processing tasks locally closer or near the source of the data in order to reduce latency in comparison to more centralized devices. An edge device is usually capable of performing computations, collecting data and executing applications as required locally and thus are not generally required to respond to large scale requests from multiple clients. Examples of edge devices are the navigation system onboard a vehicle, a mobile terminal, e.g., a smart phone, a tablet computer or the like. However, the distributed processing system is not limited to, but can extend beyond the automotive context. For example, Internet of Things (IoT) devices can also be considered edge devices, as they could be configured to execute services locally and depend on cloud infrastructure for processing tasks beyond the capabilities of the local hardware.

In addition to the edge devices 12, the plurality of computing devices also include one or more cloud computing devices 14 operating remote from the vehicle in a cloud computing environment. In an example embodiment, the cloud computing devices can handle many more requests at a much lower cost per request than an edge device, but at the expense of latency and bandwidth requirements. In the embodiment of FIG. 1, the distributed processing system 10 includes two edge devices and a single cloud computing device. In other embodiments, however, the distributed processing system may include different numbers of edge devices and/or a plurality of cloud computing devices.

As more computing power becomes available through the introduction of more capable hardware devices at the edge of the network, services are not confined to a centralized entity such as a server, cluster or “cloud”, but can also run on edge devices 12. Depending on the use case, some services may gain a performance advantage by being executed on a respective side of the network with some services gaining a performance advantage by being executed by a cloud computing device 14 and other services gaining a performance advantage by being executed by an edge device. For example, in conjunction with map matching, an edge device, such as an Infotainment system, could be dimensioned to find the corresponding road segment from positioning data provided by one source, e.g., a vehicle's position provider, while a centralized entity, e.g. a cloud computing device, could be dimensioned to take in position data from thousands of sources and return a corresponding road segment to every single source.

Each computing device 12, 14 includes a core component 16 and one or more services 18 configured to perform different functions, at least some of which are location based services. At least some and, in some embodiments, all of the services are configured to perform different functions, such as different location based services. As described below, the distributed processing system 10 may be configured to include the plurality of services that are desired by a user, such as the owner of a vehicle, without overdimensioning the vehicle with the inclusion of undesired services.

Although the computing devices 12, 14 may be configured in various manners, the computing devices of one embodiment include, are associated with or are otherwise in communication with a processor 20 and a memory device 22 and optionally a user interface 24 and/or a communication interface 26. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 20 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 20 may be configured to execute instructions stored in the memory device 22 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Some of the computing devices, such as one or more of the edge devices 12, may also optionally include or otherwise be in communication with a user interface 24. The user interface may include a touch screen display, a keyboard, a mouse, a joystick or other input/output mechanisms. In some embodiments, the user interface, such as a display, speakers, or the like, may also be configured to provide output to the user. In this example embodiment, the processor 20 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 22, and/or the like).

The computing devices 12, 14 of an example embodiment may also optionally include a communication interface 26 that may be any means such as a device or circuitry embodied in either hardware or a combination of hardware and software that is configured to receive and/or transmit data from/to other computing devices. For example, the communication interface of the cloud computing device is configured to be in communication with the communication interface of each of the edge devices. Likewise, the communication device of each edge device may be configured to be in communication with the communication interfaces of the cloud computing device and the other edge devices. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication.

As shown in FIG. 1, each computing device 12, 14 includes a core component 16. In one embodiment, each computing device includes a respective instance of the same core component. In one embodiment, the core component is defined by a plurality of computer program instructions stored by the memory device 22 of the respective computing device and executed by the processor 22 of the respective computing device. The core component performs various functions.

For example, the core component 16 of one embodiment provides cache management for the computing device 12, 14 and on behalf of the associated service 18. In one embodiment, the cache managed by the core component on behalf of a service may be a key-value data store. Within an edge device, the cache may be backed by a memory-mapped file or an embedded key-value database, while in a cloud computing device, the cache may be implemented as a distributed cache. In an embodiment in which the cache managed by the core component is a key-value data store, objects stored within the cache are retrieved by a key provided, for example, by the respective service. The key serves to uniquely identify the respective object. By way of example, keys may identify the current search request, the current route and the current application settings and the corresponding values may be the results of the current search request, the definition of the current route and the definition of the current application settings, respectively.

Other functions performed by the core component 16 may include entity state management, service administration, e.g., service discovery and/or service registry, and/or service update management. With respect to state management, the state of an entity, such as a computing device 12, 14, is a set of properties describing information known about the computing device. For example, the state of an application is the minimal set of attributes that define the application. The attributes of an example embodiment are first order attributes, that is, attributes that are not derived from other attributes. The state may be modeled as an immutable globally accessible key-value database that contains time-dependent information such that both current and past values of the state may be accessed. In an example embodiment, state updates are modeled as a tuple <time stamp, entity ID, state> in which time stamp is a time stamp of the state update in milliseconds, entity ID is an optional field defining the computing device for which the given update should apply and state is a message that captures that both the key and value of the state update. Interaction with the state service of a core component 16 may be performed in accordance with either a single get/set function or a subscription function, as described below.

The core component 16 maintains the state of the respective computing device 12, 14 and may broadcast state updates to other computing devices. The core component of an example embodiment may provide a state service that manages the state properties, such as creation, querying and update of the state properties. In one embodiment, the state service of a core component includes a key-value database and a set of application programming interfaces (APIs) that manage the access to the database and the connection mechanism. In an embodiment in which the state service is deployed by a cloud computing device, the data contained by the state service database is provided by the state services of the core components of the edge devices utilizing a shadowing mechanism. In this regard, the state services of the core components of the edge devices upload updated properties according to policies for each attribute to the state service of the core component of the cloud computing device. In one embodiment, the state service also supports create, request and update operations. A state may be created or updated with an optional entity ID. If present, the entity ID signals that the updates to the state are to be isolated from other computing devices that may be registered. Likewise, state updates without an entity ID are considered canonical and are accessible to all computing devices. Requests to the state service, however, must provide an entity ID.

The core component 16 is configured to communicate with the one or more services 18 supported by the same computing device 12, 14 and also to communicate with the core components of the other computing devices in order to coordinate execution of the plurality of services and to synchronize the core components. For example, each service may be configured to communicate with the respective instance of the core component that is executed by the same computing device as that which executes the service. The respective instances of the core components may then communicate in order to orchestrate the execution of the plurality of services. One or more of the services provide location based services that are at least partially dependent upon location data. Location data is generated in real time and, as such, location data must generally also be consumed in (near) real time to provide an acceptable user experience. In order to do that, a distributed processing system 10 of an example embodiment requires access to consistent data, in multiple devices, whenever required such that the core components must obtain and distribute the updated location data in a timely manner In one embodiment, the core components are configured to communicate with predefined set of functions, such as get, put, delete, list, subscribe, notify and stop.

In conjunction with a get function, a core component 16 may obtain a data value maintained by another core component. The data value to be obtained may be identified by a corresponding key. Conversely, in conjunction with a put or set function, a core component may cause a data value associated with a respective key to be updated, such as by inserting a new value or changing an existing value. Thereafter, the new value may be retrieved by core components of other computing devices of the distributed processing system 10. With respect to a subscription, one core component may subscribe to be notified of all changes with respect to data value(s) associated with one or more respective keys maintained by another core component. The subscription function permits a core component to subscribe to specific keys and associated data values and allows the respective core component to obtain updates for the data values to which the core component subscribed. For example, the core component associated with the routing service may subscribe to the current vehicle position. By putting a new value to an existing key, all subscribers for the respective key will be informed about the change and will adapt to the new value. Additionally or alternatively, other computing devices may be informed of a new value by a notification. In this regard, the notification function requests notification by a core component in an instance in which a data value associated with a key has changed. The list function permits a list of all keys and/or associated data values of a certain directory to be obtained. Finally, a stop function permits a prior request to be cancelled, such as by cancelling a prior notification function by which a core component would have provided notification of a change in a value of data.

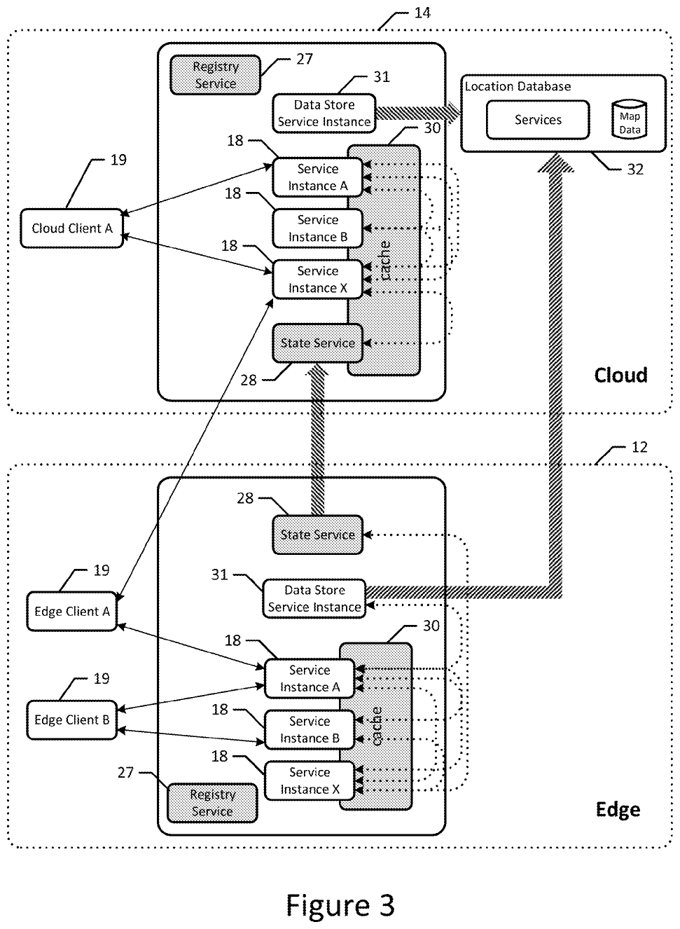

One example of inter-device communication between an edge device 12 and a cloud computing device 14 of a distributed processing system 10 is depicted in FIG. 3. As shown, each of the edge device and the cloud computing device include one or more applications 19 (termed “clients”) that are in communication with respective services 18 (termed “service instances”) executed by the same device and, in some embodiments, the service(s) of another device. The edge device and the cloud computing device also include core components 16 that, in turn, include a registry service 27 for registering new or updated service and a state service 28 configured to communicate with the state services of other devices in order to maintain consistency between the devices. The services are in communication with a local cache 30 maintained by the respective core component. To facilitate local data access, the respective devices of this example embodiment also include a data store service instance 31 configured to communicate with a location database 32 in order to download data to the respective cache and/or to provide updated data for storage.

The plurality of core components 16 communicate in such a manner as to maintain the privacy associated with the data shared between the computing devices 12, 14. In this embodiment, a function call made to the core component of a first computing device by the core component of a second computing device is accompanied by a user token. Thus, the first computing device of this example embodiment includes means, such as the processor 20, the communication interface 26 or the like, configured to receive the function call (and user token) from the second computing device. The user token is assigned exclusively to a respective user, such as the driver of the vehicle. As such, all operations on data that are performed by the core component of the first computing device based upon the function call may be performed by the core component within a secure area of the first computing device, e.g., a sandbox, and as such, the privacy associated with the data may be maintained throughout all computing devices of the distributed processing system 10. In this regard, the first computing device of this example embodiment also includes means, such as the processor or the like, configured to perform one or more operations on data in response to the function call in a secure are assigned exclusively to the user associated with the user token.

In addition to maintaining the privacy associated with the data, a distributed processing system 10 that is configured to provide services executed by different computing devices 12, 14 requires a technique for synchronizing data exchanged between the plurality of computing devices. According to Brewer's/CAP theorem, it is impossible for a distributed computer system to simultaneously provide more than two out of three guarantees: consistency, availability and partition tolerance. The distributed processing system of an example embodiment provides both availability to ensure that all services can quickly access data and partition tolerance to ensure that the system continues to operate even if partitioned. To mitigate the effects of disparity among the data sets, e.g., different versions of the data, utilized by the different computing devices of the distributed processing system brought about by a lack of consistency, the plurality of core components 16 share data having a conflict-free replicated data type (CRDT). By utilizing a CRDT, there is mathematical certainty that any conflicts that emerge within the data may be resolved, thereby also achieving consistency.

In an example embodiment, the core components 16 of the plurality of computing devices 12, 14 associated with a user are synchronized by directing a synchronization call from a core component to one or more instances of other core components associated with the same user. In response to the synchronization call, an open, bidirectional synchronization stream may be maintained between the core components to be synchronized. A first core component then sends, e.g., flushes, all of its key value pairs (along with the time stamp associated with each key value pair) to the other core component(s), that is, the second core component(s). The second core component(s) then updates the key value pairs by storing the key value pairs that are received that both differ from those currently stored by the second core component(s) and that are associated with a more recent time stamp than the time stamp of those currently stored by the second core component(s). Although the key value pairs are updated, the prior key value pairs of the second core component(s) continue to be stored along with their respective time stamp and, in some embodiments, an identifier associated with the synchronization stream that was established in response to the synchronization call. In an example embodiment, the second core component(s) also sends, e.g., flushes, all of its key value pairs (along with the time stamp associated with each key value pair) that existed prior to the update to the first core component which, in turn, updates its key value pairs in the manner described. Thus, both the first and second core components may be synchronized with the latest key value pairs, while also maintaining the prior time-stamped key value pairs.

By synchronizing the various instances of the core components 18 of the computing devices 12, 14, data is synchronized between a plurality of instances of a service. As such, the system is resilient in that even if one or more computing devices go offline, the other computing devices that remain online will include a current version of the same data. Thus, a user may rely upon one or more computing devices that may go offline in the future without concern that the system will cease properly functioning when the computing device(s) go offline since other computing devices will remain online and can provide the same services with the current version of the same data, as that which would have been utilized by the offline computing devices.

A service 18 may be executed so as to run as a single process, such as by an edge device 12 or as a separate processes, but on the same computing device with communication therebetween. Still further, a service may include a process that is executed by another computing device, such as a cloud computing device 16. In these embodiments, inter-process communication is provided. While various protocols including gRPC-Java and gRPC-Swift may be utilized, inter-process communications are provided in accordance with one embodiment by gRPC with flat buffers. gRPC provides http//2 support with authentication SSL/TLS or oAuth 2. gRPC also provides bi-directional streaming, flow control between the client and the server, and both synchronous and asynchronous RPC calls. Further, gRPC provides for cancellation and time out of RPC (remote procedure call) calls and has a robust and extensible design.

The computing devices 12, 14 of an example embodiment may provide various types of services 18 including pipelines and microservices. A pipeline may be embodied by the processor 20 and includes a plurality of computations configured to be performed in a sequential manner to generate a value. The pipeline is stateful with the value generated by the pipeline being maintained as the state of the pipeline. The core component of a respective computing device that includes the pipeline may be configured to maintain the state of the pipeline. Although a pipeline is provided by a respective computing device, the pipeline may be accessed by, e.g., subscribed to, by a plurality of computing devices thereby serving as a common resource for the plurality of computing devices.

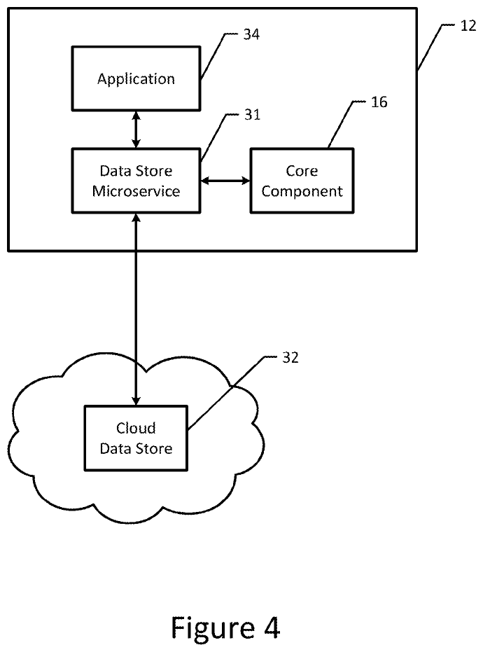

With respect to the microservices, a plurality of microservices configured to provide a variety of different services including location based services may be available. Unlike a pipeline, a microservice is stateless and, as a result, maintains no record of previous values determined by the microservice such that each time that a microservice is executed is independent the values previously generated by the microservice. One example of the microservices includes a data store microservice 31 configured to maintain a cache of tiles or partitions of mapped data local to an edge device 12 to enable faster and off-line access to the mapped data. As shown in FIG. 4, the data store microservice is configured to download and cache content from the location database 32 and will be utilized in conjunction with various applications 34, such as map rendering, routing, guidance, etc.

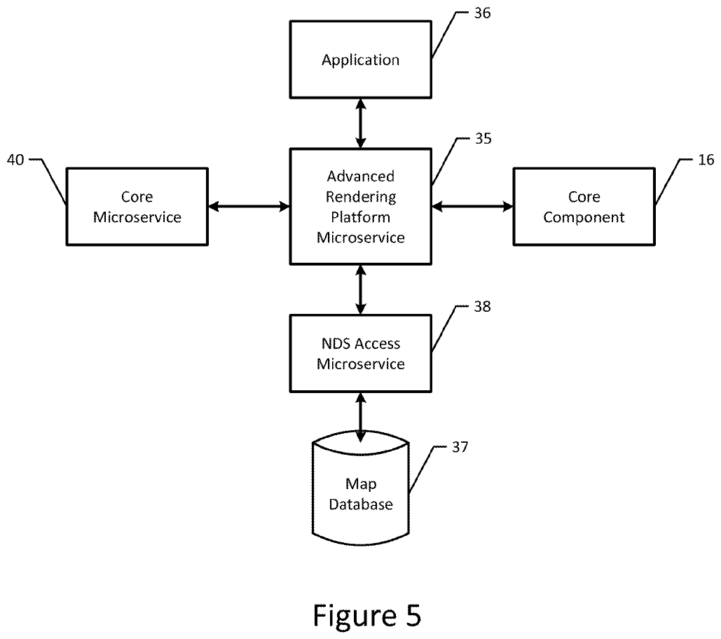

Another example microservice is an advanced rendering platform microservice 35 to provide a map rendering service for a navigation application 36 executed, for example, by an edge device. In some embodiments, the advanced rendering platform microservice may provide real-time map rendering including point features, line features, area features, roads, points of interest, as well as a marker indicative of the current location of the vehicle. One example of the advanced rendering platform microservice is depicted in FIG. 5 in which the advanced rendering platform microservice downloads map data from the map database 37, such as via an NDS (navigation data standard) access microservice 38 as discussed below. Updates to the map data and updates to the location of the vehicle may be provided on a subscription basis from a core microservice 40.

As noted above, the distributed computing system 10 may also include an NDS access microservice 38 to facilitate a centralized access to NDS data and to provide an in-memory cache for routing and the like. The NDS data may be utilized by a number of other microservices including those associated with map rendering, map matching, online speed limits and the like. Other examples of microservices are a search microservice that permits full text searching such as a search of a map or a map database for one or more terms, an online speed limits microservice and an external weather information microservice to provide real time speed limit and weather information, respectively.

A computing device 12, 14 may also be configured to function as resolver in order to define the location of each service provided by the plurality of computing devices. In this regard, the resolver may be embodied by the memory 22 of a respective computing device and may store an identification, e.g., a name, of each service as well as the location of each service. The location of each service may be represented in various manners included as a universally unique identifier (UUID). Thus, the resolver may be embodied as a key value store with the identification of each service serving as a key and the corresponding location of each service being the associated value. The resolver may publish the location of each service to the other computing devices, or the other computing devices may request the location of each service from the resolver. Based on the location information, each service may be located by the computing devices and utilized by the computing device so long as the location of service is accessible. In some embodiments, the resolver, such as a root resolver, also includes information identifying whether a service is online or offline, thereby providing additional information as to the accessibility of the service.

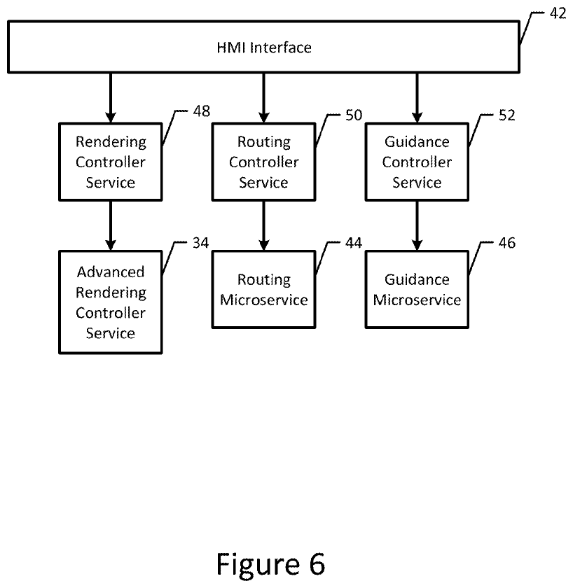

Although not a service, the distributed computing system 10 of an example embodiment may also include a human machine interface controller embodied by a computing device 12, 14 in order to interface, typically indirectly via additional business logic, with one or more services in order to implement a human machine interface (HMI). As shown in FIG. 6, for example, the HMI interface 42 may interact with the advanced rendering platform microservice 34, the routing microservice 44 and the guidance microservice 46 via business logic, such as rendering controller service 48, routing controller service 50 and guidance controller service 52, respectively. An application may be defined by a core component 18 and one or more services, such as a pipeline and/or one or more microservice, along with any additional business logic. In the foregoing example, the routing microservice and the guidance microservice, along with the associated core component, may be arranged as an application. In this example embodiment, the core component of the respective computing device is configured to provide an output of the routing microservice to the guidance microservice.

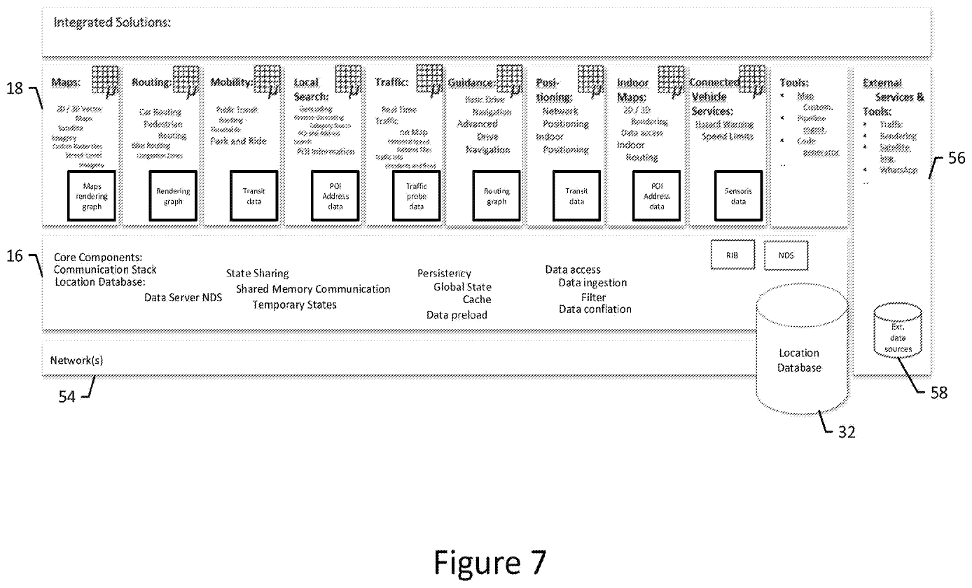

By way of further illustration of the distributed computing system 10, FIG. 7 depicts a plurality of services 18, such as pipelines and/or microservices, e.g., maps, routing, mobility, local search, traffic, guidance, positioning, indoor maps and connected vehicle services along with various tools that run on top of and interact with the core components 16. The services may be integrated, such as into pipelines, to provide various different types of services from relatively simple navigation solutions to tracking solutions to an In-Vehicle Infotainment (IVI) system. The core components can provide a plurality of different functions including, for example, one or more of maintenance of a communication stack, access to a location database including access to an NDS data server, state sharing, shared memory communication, establishment of temporary states, persistency, maintenance of a global state cache, data preload, data access, filtering of incoming data and/or data conflation. For location based services, the core components may operate in accordance with any of various bases including a reality index base (RIB) or the NDS. In addition to facilitating access to the location database, the core components can facilitate access to one or more networks 54, such as for external communication, such as to other devices and/or external resources. In this regard, various external services and tools 56 may be provided, such as for traffic, rendering, satellite imaging, etc., and that may be dependent upon one or more external data source(s) 58.

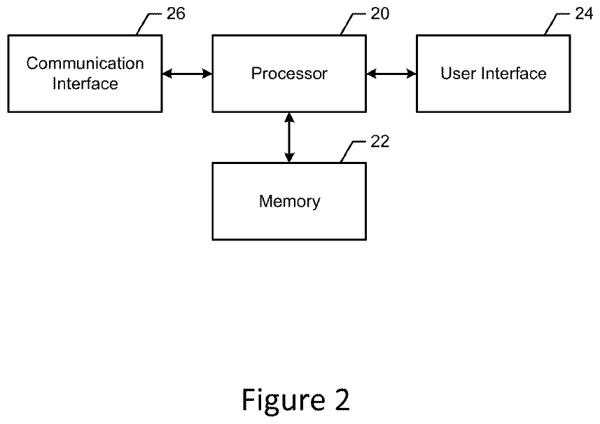

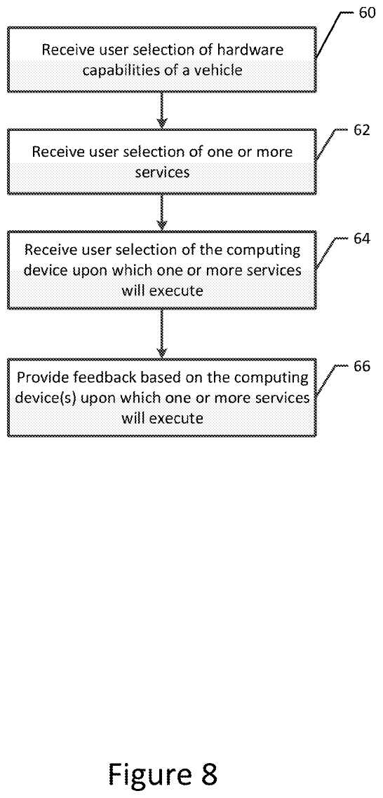

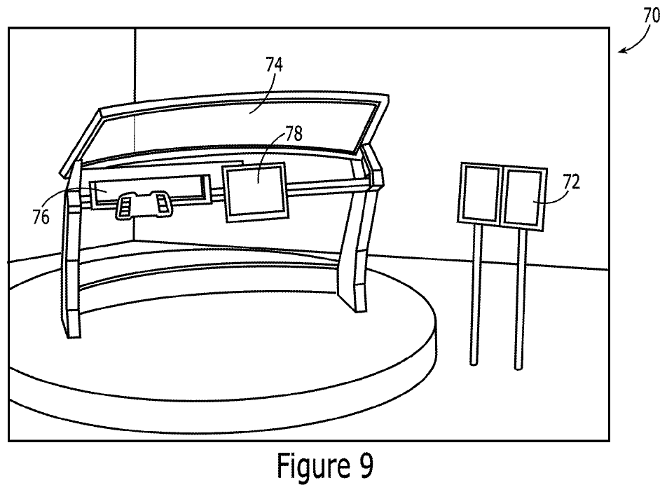

In accordance with another embodiment, a system, method and computer program product are provided in order to customize location based services to be provided onboard a vehicle. The system may be embodied by a computing device, such as is depicted, for example, in FIG. 2. Referring now to FIG. 8, the operations performed, such as by the computing device of FIG. 2, in order to customize the location based services to be provided onboard a vehicle in accordance with an example embodiment of the present invention are depicted. A number of user selections may be initially received. As shown in block 60, for example, the computing device includes means, such as the processor 20, the user interface 24 or the like, for receiving the user selection of the hardware capabilities of the vehicle. The hardware capabilities may be defined in different manners, but in one embodiment, a user selection is received as to whether the vehicle will include a cluster, mid-tier hardware or premium hardware. In the example embodiment depicted in FIG. 9, the system 70 may include a user interface, such as a display 72, that is driven by at least one processor in order to present the options of the hardware capabilities for the vehicle to the user and to receive, in response, the user selection.

Based upon the hardware capabilities, the cockpit 74 of the example vehicle will change. In an instance in which a cluster is selected, the cluster display 76 will simply include dials to indicate the speed of the vehicle. In an instance in which mid-tier hardware capabilities are selected, the head-unit display 78 of the cockpit will be of a moderate size and the cluster display will include a standard set of dials for speed and other vehicular parameters. In an instance in which premium hardware capabilities are selected, the head-unit display will be larger and more advanced and the cluster display will be more digitized with additional features. As such, the user can quickly visualize the result of their initial selection.

As shown in block 62 of FIG. 8, the computing device includes means, such as the processor 20, the user interface 24 or the like, configured to receive a user selection of one or more services with which to configure the vehicle. At least one of the services, such as a pipeline or a microservice, is configured to provide location based services. For example, examples of the services may include the display of a map, map matching in which the location of a user is identified upon a map, location search functions, routing, guidance and the provision of traffic-related information. As before, the processor of an example embodiment may cause the display 72 to present a plurality of available services and to then receive the user selection of one or more of the services.

For at least some of the services, the computing device also includes means, such as the processor 20, the user interface 24 or the like, configured to receive user selection as to whether the respective service will be executed by an edge device 12 or by a cloud computing device 14. See block 64 of FIG. 8. In this regard, the processor of an example embodiment may cause the display 72 to list the services for which user selection of the computing device is available. For the listed services, the options of an edge device or a cloud computing device may be presented and the user selection of the computing device to perform the respective service may then be received. In some embodiments, at least one and, more typically, all of the edge devices are onboard the vehicle, such as may be provided by the navigation system onboard the vehicle. As such, selection for a service to be performed by an edge device may permit the service to operate more responsively than if the same service were provided by a cloud computing device. However, execution of a respective service by the edge device that is onboard the vehicle generally require additional hardware resources, such as processing and/or memory resources, onboard the vehicle than if the same service were perform by a cloud computing device. As such, in instances in which the mid-tier hardware capabilities are selected, some of the services may be required to be performed by a cloud computing device while only a limited number of the services are able to be selected for performance an edge device.

Once the user selections regarding whether the services will be executed by an edge device 12 or by a cloud computing device 14 have been received, the computing device includes means, such as the processor 20, the user interface 24 or the like, configured to provide feedback based on whether the respective services will be executed by the edge device or by cloud computing device. See block 66. In this regard, the feedback is dependent upon whether the respective services are executed by an edge device or a cloud computing device. Various types of feedback may be provided regarding the utilization of the hardware components and the mobile data consumption including, for example, one or more parameters relating to processor usage, memory usage, network bandwidth consumption, mobile data consumption, number of remote procedure calls, number of processes or number of threads. In this regard, processor usage and memory usage may relate to the percent or amount of the processing resources and memory resources of an edge device that are consumed by the service selected to be performed by the edge device. Mobile data consumption may refer to the quantity of data transmitted between the vehicle and the cloud computing device in order to offload execution of one or more services to the cloud computing device. By reviewing the feedback including the various parameters, a user is able to gather information regarding hardware usage and data consumption and, in some embodiments may alter their selections so as to have one or more services performed by a different computing device in order to change the corresponding parameters.

Once configured, the user may enter the cockpit of the vehicle as configured with the one or more services. In the example embodiment depicted in FIG. 9, the user may enter the sample cockpit 74 in order to preview a simulated version of the vehicle that the user has configured. Alternatively, the user may enter the cockpit of the actual vehicle configured according to their selections. The computing device therefore also includes means, such as the processor 20, the communication interface 26 or the like, configured to communicate with the one or more services as well as the core component(s) of other computing device(s) in order to share data and synchronize the core components. In this regard, the computing device of an example embodiment includes means, such as the processor, the communication interface 26 or the like, configured to synchronize data between a plurality of instances of a service, such as may be implemented by different computing devices. The computing device of this example embodiment also includes means, such as the processor, the memory 22 or the like, configured to store the state of at least one service that was selected by the user. The state is stored in the core component associated with the service that was selected following execution of the at least one service that was selected. For example, the state that is stored may be a value generated by execution of the service, such as a pipeline or microservice. Once stored, the core component may be synchronized with other core components such that the other core components are updated with the state of the service.

Once in use and following execution of one or more of the services, such as the services configured to provide location based services, the computing device includes means, such as the processor 20, the user interface 24 or the like, configured to provide additional feedback relating to hardware usage and data consumption and, in one embodiment, may provide one or more parameters relating to processor usage, memory usage, network bandwidth consumption, mobile data consumption, number of remote procedure calls, number of processes or number of threads based upon actual usage as opposed to anticipated or estimated usage as provided during the configuration process as described above in conjunction with block 66 of FIG. 8. Based on this feedback from actual use, the user may again re-configure the services that have been selected and/or the computing devices to execute the services in order to alter the hardware consumption and/or data usage.

Once in use in following the initial configuration of the vehicle, the computing device includes means, such as the processor 20, the user interface 24, the communication interface 26 or the like, configured in one embodiment to receive user selection one or more additional services, such as pipelines and/or microservices, with which to further configure the vehicle. For example, the computing device, such as the communication interface, may permit access by the user to a services marketplace 80 that provides one or more additional services upon selection by the user. In this regard, the processor may be configured to obtain a listing of the additional services from the services marketplace and to present the listing upon the user interface, such as a display, for selection by the user. Based upon the selection of one or more additional services, the computing device includes means, such as the processor, the user interface or the like, configured to request from the user and to receive selection by the user of the computing device that will execute the service, such as an edge device 12 or a cloud computing device 14 and may then deploy the service in accordance with the user selection. As such, the services provided onboard the vehicle including the location based services may be further adapted following initial configuration of the vehicle, thereby further increasing the flexibility with which a vehicle may be configured with location based services.

In one embodiment, a routing microservice may be executed in order to define a route from an origin to a destination. Concurrent with the establishment of the route for the vehicle, a code, such as a QR code, or a link, such as a uniform resource locator (URL), may be provided. For example, the code or the link may be presented upon the display 78 along with the map. The code or the link may be provided to another computing device, such as a mobile telephone, a tablet computer, a smart watch, a smart glass or the like. For example, a QR code may be scanned by the other computing device or a link may be typed into the browser of the other computing device. Based upon the code or the link, the other computing device may access the route and may permit the route to be reconfigured, such as by changing the route, changing the destination, adding way points or the like. Thereafter, the reconfigured route may be communicated by the other computing device to the routing microservice and the route presented by the routing microservice may be accordingly updated in a manner consistent with the reconfigured route.

As described above, FIG. 8 illustrates a flowchart of a system, method and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 22 of a computing device employing an embodiment of the present invention and executed by a processor 20 of the computing device. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, some of which have been described above. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A distributed processing system for providing location based services, the distributed processing system comprising:
a plurality of computing devices including at least one edge device and at least one cloud computing device, each computing device comprising:
a core component; and
one or more services,
wherein instances of the one or more services of one computing device are different than instances of the one or more services of a different computing device, and wherein one or more of the services are configured to provide location based services, and
wherein the core component of each computing device is configured to communicate with the one or more services of the respective computing device as well as with the core component of at least one of the other computing devices in order to share data and synchronize the core components.

2. A distributed processing system of claim 1 wherein the one or services are selected from a group consisting of a stateful pipeline and a stateless microservice.

3. A distributed processing system of claim 2 wherein the pipeline comprises a plurality of computations configured to be performed in a sequential manner to generate a value maintained as a state of the pipeline, and wherein the core component of a respective computing device that includes the pipeline is configured to maintain the state of the pipeline.

4. (canceled)

5. A distributed processing system of claim 2 wherein the one or more services comprise a routing microservice and a guidance microservice arranged as an application, and wherein the core component of a respective computing device is configured to provide an output of the routing microservice to the guidance microservice.

6. A distributed processing system of claim 2 wherein the core component of a respective computing device is configured to communicate with the core component of another computing device in order to share data and coordinate execution of the pipeline.

7. A distributed processing system of claim 1 wherein the core component of each computing device is configured to provide cache management of data for the one or more services.

8. (canceled)

9. A distributed processing system of claim 1 wherein the core component of a respective computing device is configured to be responsive to one or more function calls from another core component, wherein the function call received by the core component of the respective computing device is associated with a user token, and wherein the core component of the respective computing device is further configured to perform one or more operations on data in response to the function call within a secure area assigned exclusively to a user associated with the user token.

10. A distributed processing system of claim 1 wherein the core components of the plurality of computing devices are configured to share data having a conflict-free replicated data type (CRDT).

11. An apparatus for providing location based services, the apparatus comprising at least one processor and at least one memory including computer program code, wherein the at least one memory and the computer program code are configured to, with the processor, cause the apparatus to:
receive user selection of one or more services, wherein at least one service is associated with a core component and is configured to provide location based services;
communicate with the one or more services as well as with a core component of another computing devices in order to share data and synchronize the core components, wherein the apparatus is caused to communicate in order to obtain the data upon which the location based services are based; and
store a state of the at least one service that was selected in the core component associated with the service that was selected following execution of the at least one service that was selected.

12. An apparatus of claim 11 wherein the one or services are selected from a group consisting of a stateful pipeline and a stateless microservice.

13. An apparatus of claim 12 wherein the pipeline comprises a plurality of computations configured to be performed in a sequential manner to generate a value maintained as a state of the pipeline.

14. An apparatus of claim 13 wherein the core component that is associated with the pipeline is configured to maintain the state of the pipeline.

15. An apparatus of claim 12 wherein the one or more services comprise a routing microservice and a guidance microservice arranged as an application, and wherein the core component associated with the one or more services is configured to provide an output of the routing microservice to the guidance microservice.

16. (canceled)

17. (canceled)

18. An apparatus of claim 11 wherein the at least one memory and the computer program code are further configured to, with the processor, cause the apparatus to:
receive one or more function calls from another core component, wherein the function call that is received is associated with a user token, and
perform one or more operations on data in response to the function call within a secure area assigned exclusively to a user associated with the user token.

19. An apparatus of claim 11 wherein the at least one memory and the computer program code are further configured to, with the processor, cause the apparatus to:
receive, for at least some of the one or more services, user selection as to whether a respective service will be executed by an edge device or in a cloud; and
provide feedback based on whether the respective service will be executed by the edge device or in the cloud, wherein the feedback comprises one or more parameters relating to processor usage, memory usage, mobile data consumption, number of processes or number of threads.

20. An apparatus according to claim 11 wherein the at least one memory and the computer program code are further configured to, with the processor, cause the apparatus to provide, following execution of one or more services, additional feedback relating to processor usage, memory usage, mobile data consumption, number of processes or number of threads.

21. A method for providing location based services, the method comprising:
receiving user selection of one or more services, wherein at least one service is associated with a core component and is configured to provide location based services;
communicating with the one or more services as well as with a core component of another computing devices in order to share data and synchronize the core components, wherein communicating comprises communicating in order to obtain the data upon which the location based services are based; and
storing a state of the at least one service that was selected in the core component associated with the service that was selected following execution of the at least one service that was selected.

22. A method of claim 21 wherein the one or services are selected from a group consisting of a stateful pipeline and a stateless microservice.

23. (canceled)

24. (canceled)

25. A method of claim 22 wherein the one or more services comprise a routing microservice and a guidance microservice arranged as an application, and wherein the core component associated with the one or more services is configured to provide an output of the routing microservice to the guidance microservice.

26. (canceled)

27. (canceled)

28. A method of claim 21 further comprising performing one or more operations on data in response to a function call from another core component, wherein the function call that is received is associated with a user token, and wherein the one or more operations are performed within a secure area assigned exclusively to a user associated with the user token.

29. A method of claim 21 further comprising:
receiving, for at least some of the one or more services, user selection as to whether a respective service will be executed by an edge device or in a cloud; and
providing feedback based on whether the respective service will be executed by the edge device or in the cloud, wherein the feedback comprises one or more parameters relating to processor usage, memory usage, mobile data consumption, number of processes or number of threads.

30-38. (canceled)
